(19) United States
(12) Patent Application Publication
(10) Pub. No.: US 2006/0128169 A1
(43) Pub. Date: Jun. 15, 2006

(54) Textile interconnect

(75) Inventors: George Marmaropoulos, Briarcliff Manor, NY (US); Giang T. Vu, Briarcliff Manor, NY (US); Katherine Pulford, Briarcliff Manor, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/560,710

(22) PCT Filed: Jun. 29, 2004
(86) PCT No.: PCT/IB04/51044

§ 371 Date: Dec. 15, 2005

(30) Foreign Application Priority Data
Jun. 30, 2003 (US) 60483763

(51) Int. Cl. H01R 33/00

(52) U.S. Cl. 439/37

(57) ABSTRACT

There is provided a flexible, lightweight high-performance textile interconnect 1 cooperative with a variety of different textiles such as those commonly used in garments or upholstery, as well as with any of a variety of different electronic devices/systems without unwantedly compromising the innate properties/characteristics of such textiles. The interconnect having one or more sockets (10) fashioned from a flexible textile construction (12) and one or more jacks (20) mechanically and/or electrically connectable with the one or more sockets (10). The one or more sockets (10) being collapsible and having one or more conductive contact areas (14) situated therein. The one or more jacks (20) can have a gripping concertina-like engaging portion (21) for improving the mechanical and/or electrical connection with the one or more sockets (10).

The present invention relates to textile electronics. More particularly, the present invention relates to a conductive textile interconnect having one or more sockets of a flexible fiber construction that are cooperative with one or more jack connectors.

The use of electronics in various manufactured materials is well known; see for example, U.S. Pat. Nos. 6,360,615 B1, 6,210,771 B1, and 5,371,326; U.S. Patent Application Publication Nos. 2002/0135457 A1 and 2002/0076949 A1; PCT International Patent Publication Nos. WO 02/055923 A1 and WO 02/32665 A1; and/or UK Patent Application No. GB 2 373 863. Devices such as conductive traces, bio-sensors, electrodes, computers, electronic circuits and the like have all been incorporated into textiles. As the benefits associated with the various types and/or configurations of textile electronics become more apparent, the desirability and need for simple, effective and efficient, and intuitive electronic interconnecting solutions becomes more apparent. Hence, there is a need for an interconnect that is complementary to the various electronic devices/systems associated with the different textile electronics and/or the materials accommodating such electronics.

It is an object of the present invention to provide an interconnect suitable to address the above-identified need for simple, effective and efficient, as well as intuitive textile interconnect solutions.

It is another object of the present invention to provide such an interconnect that provides a secure and effective mechanical and/or electrical connection.

It is another object of the present invention to provide such an interconnect having one or more socket connectors of a flexible textile construction and being cooperative with one or more jack connectors.

It is another object of the present invention to provide such an interconnect having one or more adjustable jack connectors for facilitating a secure and effective mechanical and/or electrical connection.

It is another object of the present invention to provide such an interconnect having an actuator operative to accomplish the adjustment of the one or more adjusting jack connectors.

It is another object of the present invention to provide such an interconnect cooperative with a garment, with upholstery and/or with one or more electronic devices/systems.

It is another object of the present invention to provide such an interconnect that is suitable to provide a safe and effective mechanical and/or electrical connection between and/or among various textile electronics.

These and other objects and advantages of the present invention are achieved by an interconnect having one or more socket connectors having a flexible textile construction and being cooperative with one or more jack connectors. The one or more jack connectors can be either of a conventional type or of an adjustable type. Thus, the interconnect provides for a soft, flexible mechanical and/or electrical connection for various textile electronic devices/systems and/or materials.

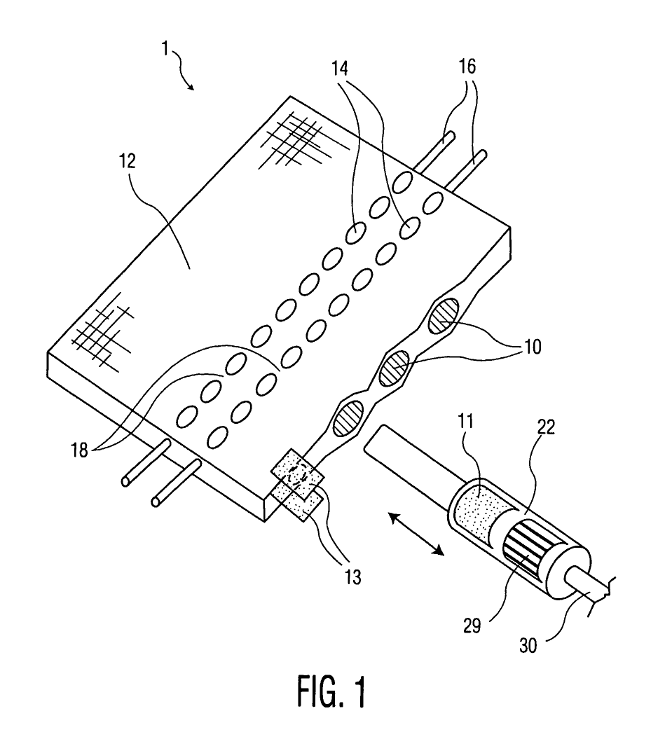

FIG. 1 is a perspective view of an interconnect in accordance with an illustrative embodiment of the present invention;

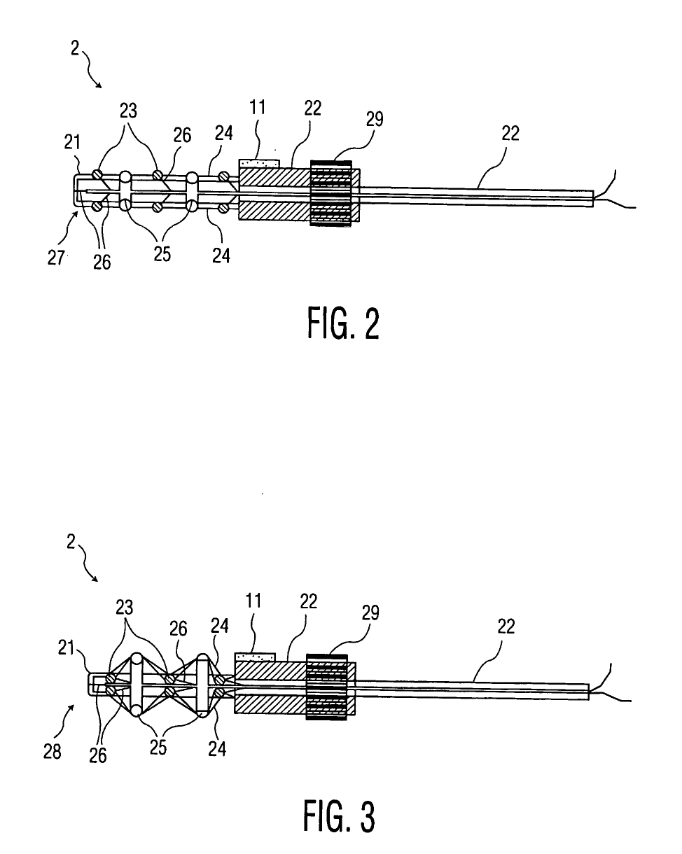

FIG. 2 is a section view of a jack connector in accordance with an illustrative embodiment of the present invention, showing the jack connector in a first state;

FIG. 3 is a section view of the jack connector of FIG. 2, showing the jack member in a second state;

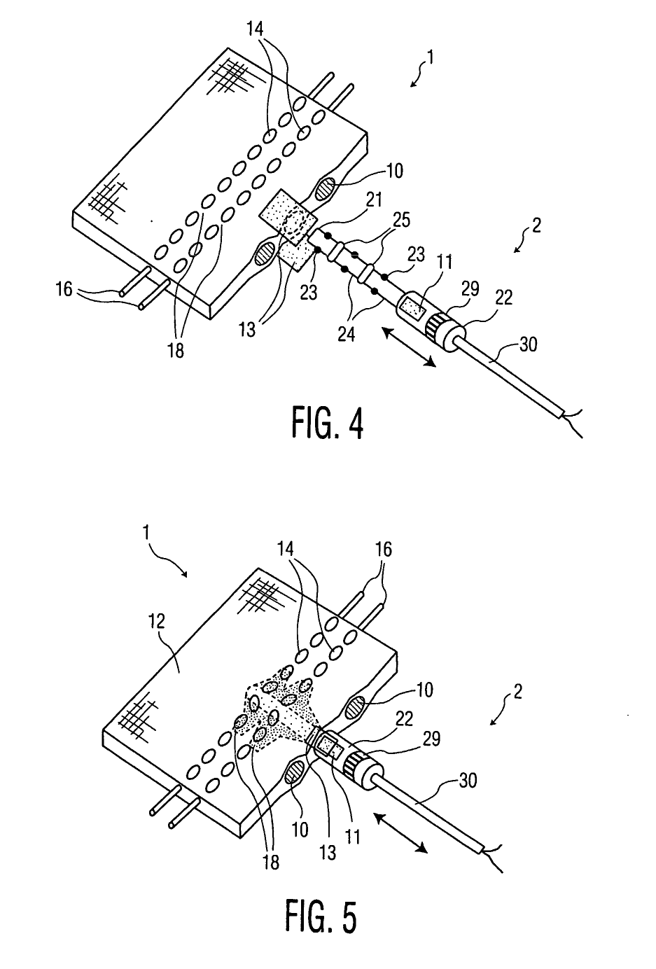

FIG. 4 is a perspective view of the interconnect of FIG. 1 cooperating with the jack element of FIG. 2;

FIG. 5 is a plan view of a garment having an interconnect in accordance with an illustrative embodiment of the present invention.

Referring to the drawings and, in particular, FIG. 1, an interconnect in accordance with an illustrative embodiment of the present invention is shown and generally represented by reference numeral 1. Preferably, the interconnect 1 has one or more sockets 10 fashioned of a flexible textile construction 12. The one or more sockets 10 preferably are cooperative or operatively connectable with one or more connecting jacks 20. The one or more jacks 20 being of any known conventional type commonly associated with various electronic devices/systems.

Preferably, the one or more sockets 10 are integrally formed with the textile construction 12, but they may also be separately connected to the textile construction 12 via any suitable method for accomplishing such a task. The one or more sockets 10 preferably have and/or cooperate with one or more conductive contact areas 14.

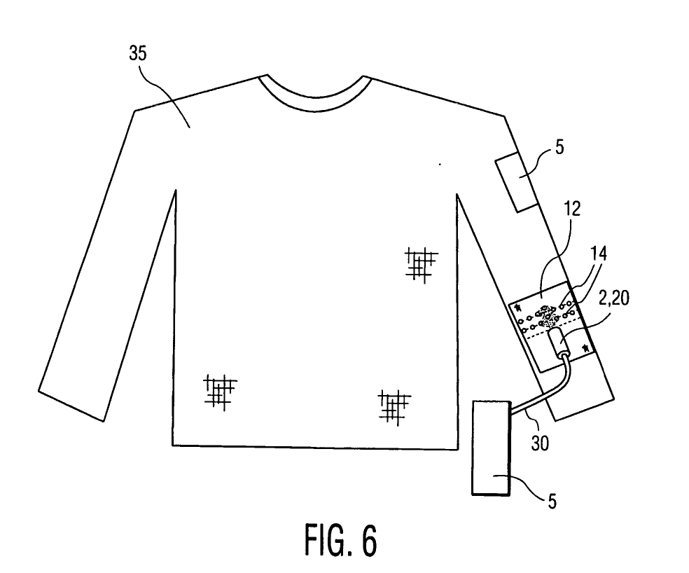

The one or more conductive contact areas 14 preferably facilitate an operative electrical connection with the one or more jacks 20. Preferably, the one or more conductive contact areas 14 can be integrally formed the textile construction 12 and/or the one or more sockets 10, but they may also be separately connected thereto via any suitable method for accomplishing such a task. The one or more conductive contact areas 14 are preferably fashioned from material having at least some conductive characteristics. The one or more conductive contact areas 14 are preferably in electrical communication with one or more conductive leads 16, which in turn, are in electrical communication with any of a variety of different electronic devices/systems 5 (see FIG. 6).

The one or more conductive leads 16, like the one or more conductive contact areas 14, can either be integrally formed with the textile construction 12 and/or the one or more sockets 10, or separately connected thereto via any suitable method for accomplishing such a task. The one or more conductive leads 16 are preferably fashioned from material having at least some conductive characteristics. Preferably, the one or more conductive leads 16 and the one or more conductive contact areas 14 are internal to the textile construction 12 so as to be insulated and to prevent any undesirable contact therewith. However, they may also be external to the textile construction 12 should there be a particular reason and/or need to do so. It is noted that the one or more conductive contact areas 14 and/or the one or more conductive leads 16 can be formed into one or more tracks 18 to facilitate multiple and/or simultaneous connections operative as a hub for two or more electronic devices/systems 5.

The one or more sockets 10 can also be collapsible such that absent the presence of the one or more jacks 20 the one or more sockets 10 collapse or close to become discreet or substantially hidden. Preferably, the one or more sockets 10 effortlessly inflate or open to accommodate the one or more jacks 20, thereby making it easy for a user to connect the one or more jacks 20 with the one or more sockets 10.

It is noted that one or more fasteners 13, such as for example, a Velcro or a loop-hook system, may be used to selectively secure the one or more sockets 10 closed. A sealing mechanism may also be used to waterproof and/or insulate the one or more sockets 10.

It is further noted that the textile construction 12 and/or the various components thereof can preferably be fashioned from a variety of natural and/or manmade materials using any method known for weaving, sewing, knitting, laminating, bonding, or fusing, as well as any other appropriate method for constructing a textile.

Referring to FIGS. 2 and 3, an adjustable connecting jack in accordance with an illustrative embodiment of the present is shown and generally represented by reference numeral 2. The adjustable jack 2 preferably has an engaging portion 21 and a body portion 22.

The engaging portion 21 preferably has one or more joints 23, two or more segments 24 preferably interconnected by the one or more joints 23, one or more conductive areas 25, and one or more actuators 26 cooperative with the one or more joints 23 and/or the one or more segments 24 to facilitate a concertina type adjusting action. It is noted however, that other configurations and/or arrangements may also be used in order to satisfy different connection types. For example, the engaging portion can be configured to telescopically adjust or to spreadingly open in flare or fan-like manner such that one end has a larger cross-sectional area than the other.

The one or more joints 23 and the one or more segments 24 are preferably operative to facilitate adjusting the engaging portion 21 between at least a first state 27, such as that shown in FIG. 2, and a second state 28, such as that shown in FIG. 3. The concertina type adjusting of the engaging portion 21 between the at least first state 27 and second state 28 preferably facilitates a more secure mechanical and/or electrical connection. This concertina type adjusting is preferably accomplished via a mechanical interaction.

The one or more conductive areas 25 of the engaging portion 21 are preferably optimally located to be operatively, mechanically and/or electrically connectable with the one or more conductive contact areas 14 of the textile construction 12 and/or the one or more sockets 10 when in engagement therewith. It is noted that the one or more conductive areas 25 of the engaging portion 21 can preferably be fashioned from a variety of natural and/or manmade materials having conductive properties.

The engaging portion 21 preferably provides for a safe and secure mechanical and/or electrical connection.

The body portion 22 can have at least one controller 29 for influencing the adjustment of the engaging portion 21. Preferably, the at least one controller 29 is cooperative or operatively connected with the one or more actuators 26 to manipulate (e.g., retract or collapse) the engaging portion 21. This manipulation preferably creates a gripping concertina-like action suitable to improve the mechanical and/or electrical connection between the engaging portion 21 and the one or more sockets 10. It is noted that the manipulation may be incremental and/or instantaneous to accommodate any of a variety of different connection types.

Alternatively, the at least one controller 29 can be a bias control for managing a spring bias associated with the one or more actuators 26. For example, the one or more actuators 26 can have an innate bias that can be either directly or indirectly manipulated via the at least one controller 29 to transform the engaging portion 21 into the gripping concertina-like action suitable to improve the mechanical and/or electrical connection between the engaging portion 21 and the one or more sockets 10. It is noted that the bias manipulation may be accomplished incrementally and/or immediately to accommodate any of a variety of different connection types.

The body portion 22 can also be operatively connected with a connector 30 electrically and/or mechanically connectable with any of a variety of different electronic devices/systems 5. The connector 30 can have any configuration suitable to facilitate an electrical communication. The body portion 22 can further have a securing member 11 that is cooperative with the one or more fasteners 13 of the socket 10 to provide an additional security against any inadvertent/unwanted disengagement of the jack 2 and the one or more sockets 10. Other configurations and/or arrangements may also be used. For example, controller 29 can be sliding member associated with the body portion 22 of the jack 20 and operatively connected with the one or more actuators 26.

In sum, the interconnect 1 is preferably a highly flexible/resilient, lightweight high-performance intuitive interconnect that is cooperative or operatively integrated in and/or connectable with a variety of textiles such as garments and/or upholstery 35 without compromising the inherent characteristics or properties (e.g., comfort or durability) of such textiles.

The present invention having been thus described with particular reference to the preferred forms thereof, it will be obvious that various changes and modifications may be made therein without departing from the spirit of the present invention as defined herein.

What is claimed is:

1. An interconnect (1), comprising:
one or more socket connectors (10) of a flexible textile construction (12); and
one or more jack connectors (20),
wherein said one or more jack connectors (20) are operatively connectable with said one or more socket connectors (10).

2. The interconnect (1) of claim 1, wherein said one or more socket connectors (10) have one or more conductive contact areas (14).

3. The interconnect (1) of claim 2, wherein said one or more jack connectors (20) have one or more conductive areas (25) operatively connectable with said one or more conductive contact areas (14) of said one or more socket connectors (10).

4. The interconnect (1) of claim 1, wherein said one or more socket connectors (10) are collapsible so as to be substantially unnoticeable when void.

5. The interconnect (1) of claim 1, wherein said one or more jack connectors (20) have a concertina-like engaging portion (21).

6. The interconnect (1) of claim 1, wherein said one or more jack connectors have an engaging portion (21) with one or more joints (23), one or more segments (24), and one or more actuators (26) cooperative with said one or more joints (23) and/or said one or more segments (24) to influence said engaging portion (21).

7. The interconnect (1) of claim 3, wherein said one or more jack connectors (20) have a concertina-like engaging portion (21) operatively connectable with said one or more socket connectors (10) to facilitate said one or more conductive contact areas (14) being mechanically and/or electrically connected with said one or more conductive areas (25).

8. A garment or upholstery (35) having the interconnect (1) of claim 1.

9. An interconnect (1), comprising:
a socket (10); and
a jack (2) with a concertina-like engaging portion (21) and a body portion (22).

10. The interconnect (1) of claim 9, wherein said socket is fashioned from a textile construction (12).

11. The interconnect (1) of claim 9, wherein said socket has one or more conductive contact areas (14).

12. The interconnect (1) of claim 9, wherein said socket is collapsible so as to be substantially unnoticeable when void.

13. The interconnect (1) of claim 9, wherein said concertina-like engaging portion (21) has one or more joints (23), one or more segments (24), one or more conductive areas (25), and one or more actuators (26) cooperative with said one or more joints (23) and/or said one or more segments (24) to facilitate in manipulating said engaging portion (21).

14. The interconnect (1) of claim 13, wherein said manipulation of said engaging portion (21) is accomplished via a controller (29).

15. The interconnect (1) of claim 14, wherein said controller (29) is a bias control for managing a bias associated with said one or more actuators (26), said one or more segments (24), and/or said one or more joints (23) to bring said one or more conductive areas (25) into mechanical and/or electrical communication with one or more contact areas (14) of said socket (10).

16. The interconnect (1) of claim 14, wherein said controller (29) is a sliding member associated with said body portion (22) of said jack (20).

17. A garment or upholstery (35) having the interconnect (1) of claim 9.

18. A method for using a textile interconnect (1) comprising the steps of:
providing one or more sockets (10), said one or more sockets (10) being fashioned from a flexible textile construction (12) and having one or more conductive contact areas (14);
providing one or more jacks (20), said one or more jacks (20) being mechanically and/or electrically connectable with said one or more sockets (10) and having one or more conductive areas (25); and
engaging said one or more jacks (20) with said one or more sockets (10) such that said one or more conductive areas (25) are in mechanical and/or electrical communication with said one or more conductive contact areas (14).

19. The method of claim 19, further comprising a step of: adjusting said one or more jacks (20) via a mechanical interaction to provide a more secure mechanical and/or electrical connection with said one or more sockets (10).

20. The method of claim 19, wherein said mechanical interaction is accomplished via a controller (29), one or more actuators (26), one or more segments (24), and/or one or more joints (23).
